(19) United States
(12) Patent Application Publication
(10) Pub. No.: US 2008/0288265 A1
(43) Pub. Date: Nov. 20, 2008

(54) Energy Efficiency Compliance System And Methods

(75) Inventors: Heidi Ailee Wollert, Littleton, CO (US); Marcus Vinicius Andrade Bianchi, Littleton, CO (US)

Correspondence Address: JOHNS MANVILLE, 10100 WEST UTE AVENUE, PO BOX 625005, LITTLETON, CO, 80162-5005, US

(73) Assignee: Johns Manville, Littleton, CO (US)

(21) Appl. No.: 11/748,854

(22) Filed: May 15, 2007

(51) Int. Cl. G06Q 50/00; G06F 17/30; G06F 3/01

(52) U.S. Cl. 705/1; 707/104.1

(57) ABSTRACT

A compliance system configured to assist a user with the selection of building materials that comply with a regulatory requirement includes a processor, a forms generator, and a user interface. The processor is programmed to receive a first user input via the user interface, which first user input identifies a geographic area within a larger compliance region to which the regulatory requirement relates. The geographic area has particular compliance parameters associated therewith. The processor also is programmed to receive a second user input via the user interface, which second user input identifies a first building material, based on the first and second user inputs, identify a second building material usable in combination with the first building material to comply with the regulatory requirement, and, via the forms generator, generate one or more forms that document compliance with the regulatory requirement.

### FIELD OF THE INVENTION

Embodiments of the present invention relate generally to compliance tools. More specifically, embodiments of the present invention relate to system and methods for determining and documenting compliance with a requirement (e.g., law or regulation) involving at least some degree of computation.

### BACKGROUND OF THE INVENTION

It has become common for regulating bodies (e.g., federal or state governments) to enact regulations that require a regulated entity (e.g., a business) to comply with regulations having multiple compliance paths, or options, and then to demonstrate compliance with the regulation through the completion of tedious documentation. The tax laws may be the most common such example. Pollution reduction laws are a more recent example.

In some cases, the regulations provide a “prescriptive” compliance method that may require little or no computation but also provide an “alternative” compliance method that is computationally challenging. Such is the case with California's Title 24, specifically Part 6, which regulates certain roofing systems.

### BRIEF SUMMARY OF THE INVENTION

Embodiments of the invention provide a compliance system configured to assist a user with the selection of building materials that comply with a regulatory requirement. The system includes a processor, a forms generator, and a user interface. The processor is programmed to receive a first user input via the user interface, which first user input identifies a geographic area within a larger compliance region to which the regulatory requirement relates. The geographic area has particular compliance parameters associated therewith. The processor also is programmed to receive a second user input via the user interface, which second user input identifies a first building material, based on the first and second user inputs, identify a second building material usable in combination with the first building material to comply with the regulatory requirement, and, via the forms generator, generate one or more forms that document compliance with the regulatory requirement. According to certain embodiments, users are advantageously able to easily identify products usable to satisfy regulatory requirements specific to their jurisdiction and complete the forms necessary to demonstrate compliance with the requirements.

In some embodiments, the regulatory requirement relates to energy efficiency requirements for a building. The regulatory requirement may relate to a roofing requirement. The regulatory requirement may relate to California Code of Regulations Title 24, Part 6. The first user input may be a zip code. The zip code may be usable by the processor to identify a climate zone within which the building materials are to be used. The first and second building materials may be different components of a roofing system. The compliance system may include a material list generator and the processor may be further configured to, via the material list generator, generate a list of materials. The compliance system also may include a jurisdictional table identifying regulatory requirements for one or more jurisdictions within which the building materials are usable, a climate zone table identifying climate data for a plurality of climate zones within which the building materials are usable, and a material properties table identifying material properties for a plurality of building materials.

Other embodiments provide a method of complying with a regulatory requirement relating to energy efficiency. The method includes providing a computer-implemented compliance tool, providing data to the tool that defines a first building material and a compliance location, and receiving from the tool information defining a second building material usable in combination with the first building material to comply with the regulation at the compliance location. The regulatory requirement may relate to a roofing requirement. The regulatory requirement may relate to California Code of Regulations Title 24, Part 6. The first and second building materials may be different components of a roofing system. The method may include generating a project-specific materials list. The method also may include generating one or more project-specific compliance forms.

Still other embodiments provide a method of complying with an energy efficiency standard relating to roofing systems. The method includes providing a compliance tool that is configured to receive information from a user defining at least a first component in a multi-component roofing system and to identify at least a second component in the multi-component roofing system. The first and second components are usable in combination to comply with the energy efficiency standard. The compliance tool is further configured to generate one or more forms acceptable to a regulatory agency as documentation of compliance with the energy efficiency standard. The method also includes inputting into the tool data defining the first component and outputting from the tool data defining the second component. The energy efficiency standard may relate to California Code of Regulations Title 24, Part 6. The method also may include generating a project-specific materials list. The method may include generating one or more project-specific compliance forms.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a building standards compliance system according to embodiments of the invention.

FIG. 2 depicts a building standards compliance method according to embodiments of the invention, which method may be implemented in the system of FIG. 1.

FIGS. 3A to 3F depict display screens in an exemplary compliance tool.

FIGS. 4A to 4C depict exemplary forms that may be generated using a compliance tool according to embodiments of the present invention.

### DETAILED DESCRIPTION OF THE INVENTION

Embodiments of the present invention relate to building standards compliance systems and methods. In order to provide a context for describing embodiments of the present invention, embodiments of the invention will be described herein with reference to systems and methods for complying with energy standards for roofing systems. Those skilled in the art will appreciate, however, that other embodiments are possible. For example, embodiments of the invention may be used to comply with standards for whole house energy efficiency and the like.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Specific embodiments of the invention are directed to systems and methods for complying with Part 6 of California's Title 24, which provides energy efficiency standards for, among other things, roofing systems. Title 24 includes a prescriptive compliance method that sets minimum reflectivity and emissivity standards for certain roofing systems. As long as a selected roofing system meets the standards—0.70 and 0.75, respectively—then the roofing system is in compliance. But reflectivity and emissivity are merely components of a more important energy efficiency standard: heat gain or heat loss (i.e., negative gain).

Heat gain is a measure of a building's energy efficiency with respect to heating and cooling. While reflectivity and emissivity are factors that affect a building's heat gain, Title 24 compliance recognizes that a roofing system may fail to comply with the prescriptive emissivity and/or reflectivity standards yet produce an energy budget that is better than the budget a prescriptively-compliant roofing system would produce. Title 24 therefore allows a building owner to demonstrate compliance with Title 24 while using roofing systems having reflectivity and/or emissivity factors that do not meet the prescriptive standards. The owner demonstrates compliance by documenting that the chosen roofing system improves the annual energy budget with respect to a prescriptively-compliant system.

Embodiments of the present invention therefore provide systems and methods for compliance, specifically compliance with energy efficiency standards for buildings. The system receives user inputs, performs calculations based on the user's inputs, and suggests or identifies building components necessary for compliance. The system also produces approved forms that document compliance, which forms the user may provide to a regulating body.

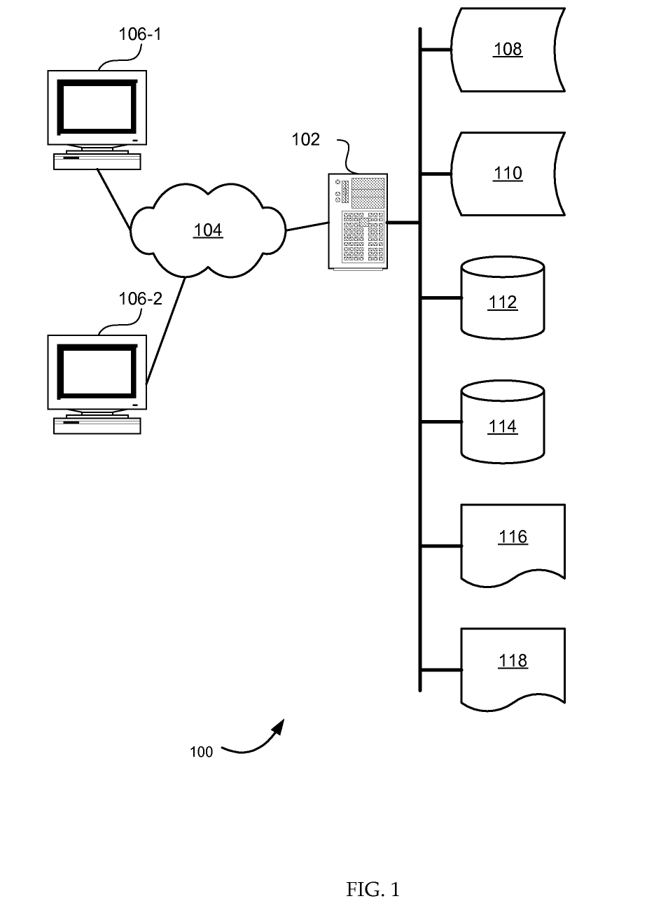

Having described embodiments of the invention generally, attention is directed to FIG. 1, which depicts an exemplary compliance system 100 according to embodiments of the invention. Those skilled in the art will appreciate that the system 100 is merely exemplary of a number of possible embodiments. The system 100 includes a compliance tool 102, which may be any of a variety of suitable computing devices (e.g., desktop computer, lap top computer, server, etc.) appropriately programmed to implement embodiments of the invention. For example, the compliance tool 102 may include a processor and software and may be configured to serve web pages via a network 104 to user computers 106. Those skilled in the art will appreciate that the compliance tool 102 may be embodied in a single computing device or may be embodied in a number of geographically-distributed computing devices. The compliance tool 102 also may include a variety of input and output devices and/or other peripherals.

In this specific embodiment, the compliance tool 102 includes a number of components that function together to perform method embodiments of the present invention. For example, the compliance tool 102 includes: a table of jurisdictions 108 that allows the same tool to aid compliance in multiple jurisdictions; a table of climate zones 110 that allows the compliance tool 110 to be used across a number of different climate zones; a forms database 112 that allows the tool 102 to produce a variety of compliance forms; a materials database 114 that provides information on a number of different materials; a forms generator 116 that generates project specific compliance forms; and a materials list generator 118 that produces a project specific materials list. Those skilled in the art will appreciate that other exemplary embodiments may include different components than those listed and described herein.

According to embodiments of the invention, users may access the tool using the user computers 106. The user supply project data that is used to select project-specific parameters from the table of jurisdictions 108 and/or the table of climate zones 110. The parameters may include temperature coefficients, compliance standards, and/or the like. Users also provide information that generally defines the type of building system the user desires to implement. For example, in a specific embodiment relating to roofing systems, a user may specify a bituminous roof, which has several components, namely a membrane and a cover board. The system also may include insulation. The user may select a specific component to use in the system. Based on the user's selection of a particular system and component, the tool will locate material properties for the selected component and provide one or more possible selections for other components, such as the cover board. If the user has additional options, then the user may select from among the other options (e.g., cover board), and the tool may finally specify a minimum amount of insulation needed to implement a compliant system.

Continuing with a description of this specific embodiment relating to roofing systems, in determining additional suitable materials to suggest or require, the tool may calculate an energy budget for a prescriptively-compliant roofing system for the specific project. The energy budget is based on a specific period of time (e.g., annual) to thereby account for seasonal variation. As the user specifies roofing system components to be used in an alternative compliance roofing system, the tool narrows the range of acceptable complementary components necessary for the alternative system to have the same or better energy budget as the prescriptively-compliant system. In some cases, the range of acceptable components may not meet the energy budget for a prescriptively-compliant system, in which case additional materials (e.g., insulation) may be required to bring the total system into compliance.

Once the compliant system is determined, the tool may generate a materials list for the project. The tool also may generate compliance forms that document that the roofing system complies with the standards.

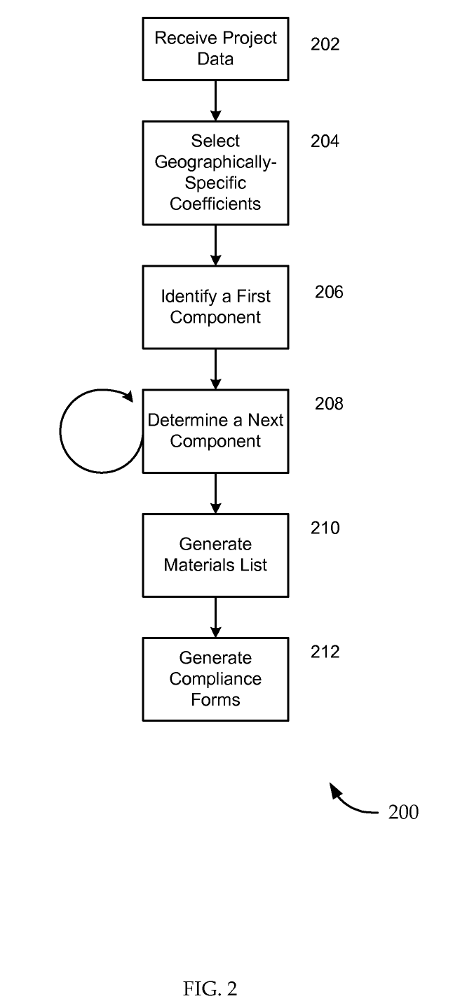

Having described an exemplary system according to embodiments of the invention, attention is directed to FIG. 2, which depicts an exemplary method 200 according to embodiments of the invention. The method may be implemented in the system 100 of FIG. 1 or other appropriate system. It should be understood that other exemplary method embodiments may include more, fewer, or different steps than those illustrated and described herein. Moreover, other exemplary embodiments may traverse the steps herein in orders different that that shown here.

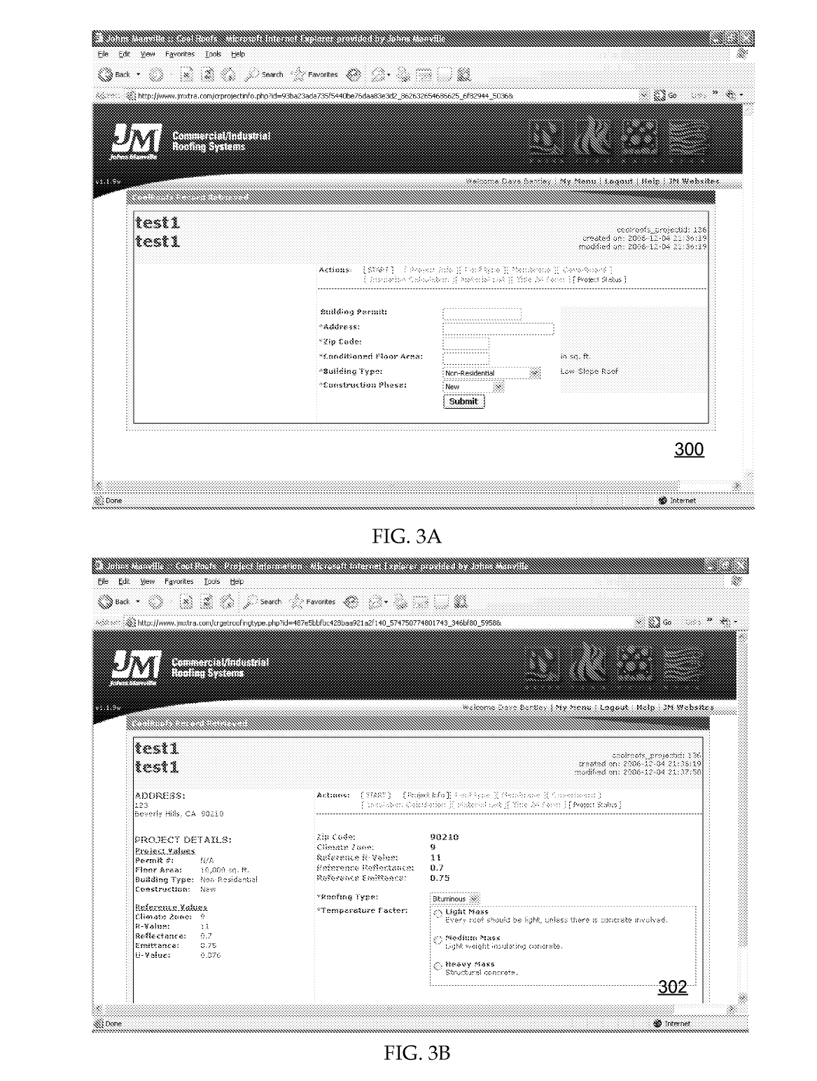

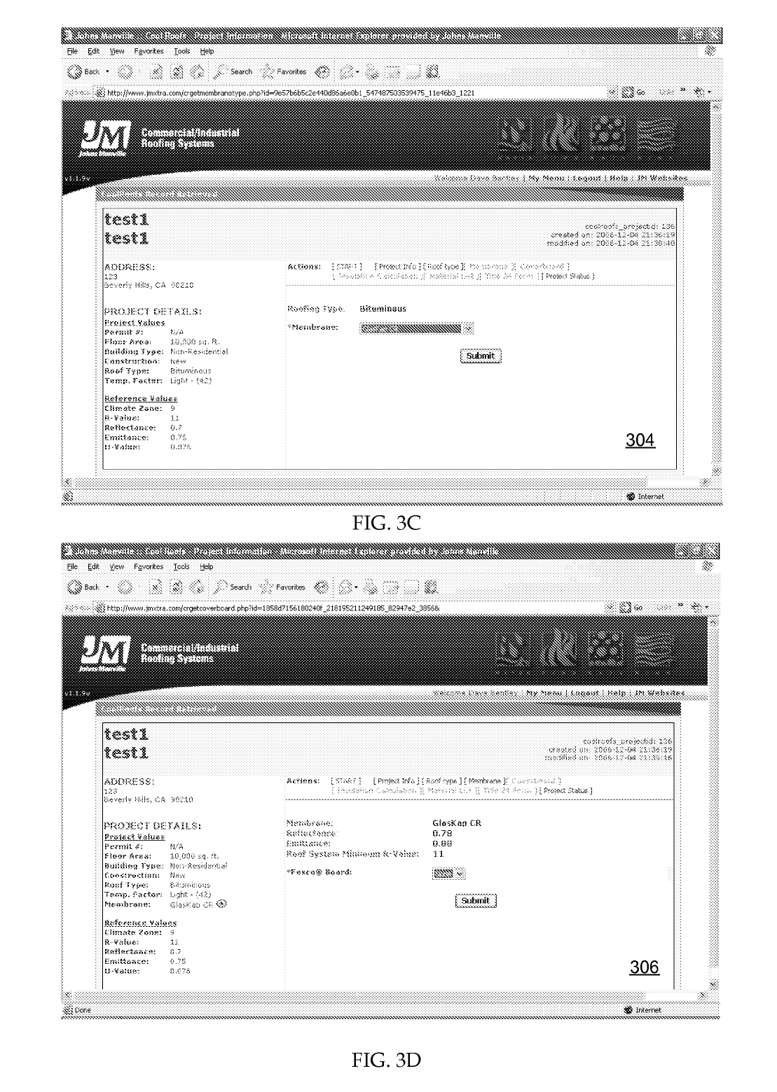

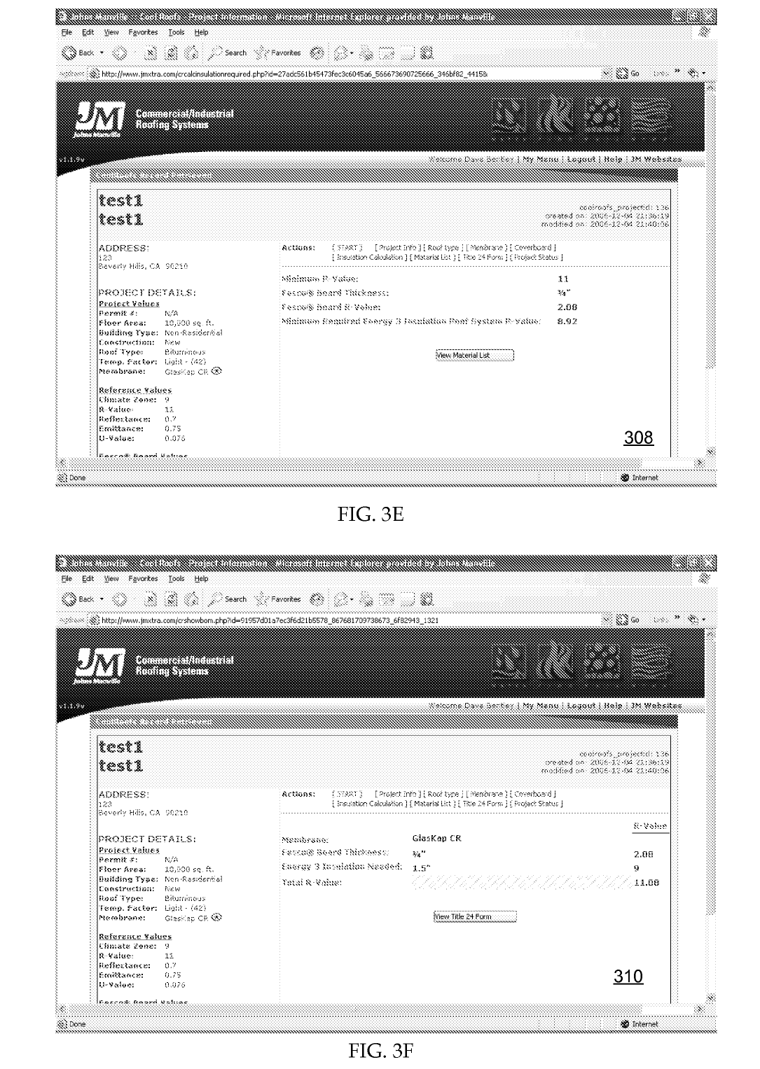

The method 200 begins at block 202 at which point the user supplies general project data. The project data may include a site address (including zip code), building size (square feet, number of floors, etc), type of construction (new or rework, stick, steel, cement, etc.), building type (commercial or residential, etc.), and/or the like. FIG. 3A depicts a display screen 300 that may be used to receive such project data from the user. The display screen includes data entry fields, which may include drop down menus, pick lists, radio buttons, and/or the like. Once the user submits the project data, the tool selects geographically-specific and/or jurisdictionally-specific coefficients and/or standards at block 204.

For this specific embodiments relating to roofing systems compliant with energy efficiency standards, the user may identify a particular roof system and/or identify a specific component of the system. For example, as depicted in FIG. 3B, the display screen 302 may be used to specify a bituminous roof. Then the display screen 304 of FIG. 3C may be used to specify a particular membrane, in this case the GlasKap CR™ membrane, a product of Johns Manville. These steps are depicted as block 206 of FIG. 2.

Based on the information provided by the user to this point, the tool provides selection criteria for additional system components. For example, based on the reflectivity and emissivity characteristics of GlasKap CR, the climate zone, building size, construction type, jurisdictional requirement, etc., the tool determines acceptable cover board thicknesses. This is depicted as block 208 of FIG. 2 and shown in the display screen 306 of FIG. 3D. If the user has options, then the user selects from among the options.

As indicated, the method 200 may cycle through the actions of block 208, specifying additional components. For example, as depicted in the display screen 308 of FIG. 3E, a cover board thickness of ¾″, together with the chosen membrane may require additional insulation. In this example, insulation having an R-Value of 8.92 is needed.

Once all materials are identified, the tool may generate a materials list. This is depicted as block 210 of FIG. 2 and shown in the display screen 310 of FIG. 3F. In this example, the materials list includes GlasKap Cr membrane, ¾″Fesco® cover board, and 1.5″ of Energy 3 insulation.

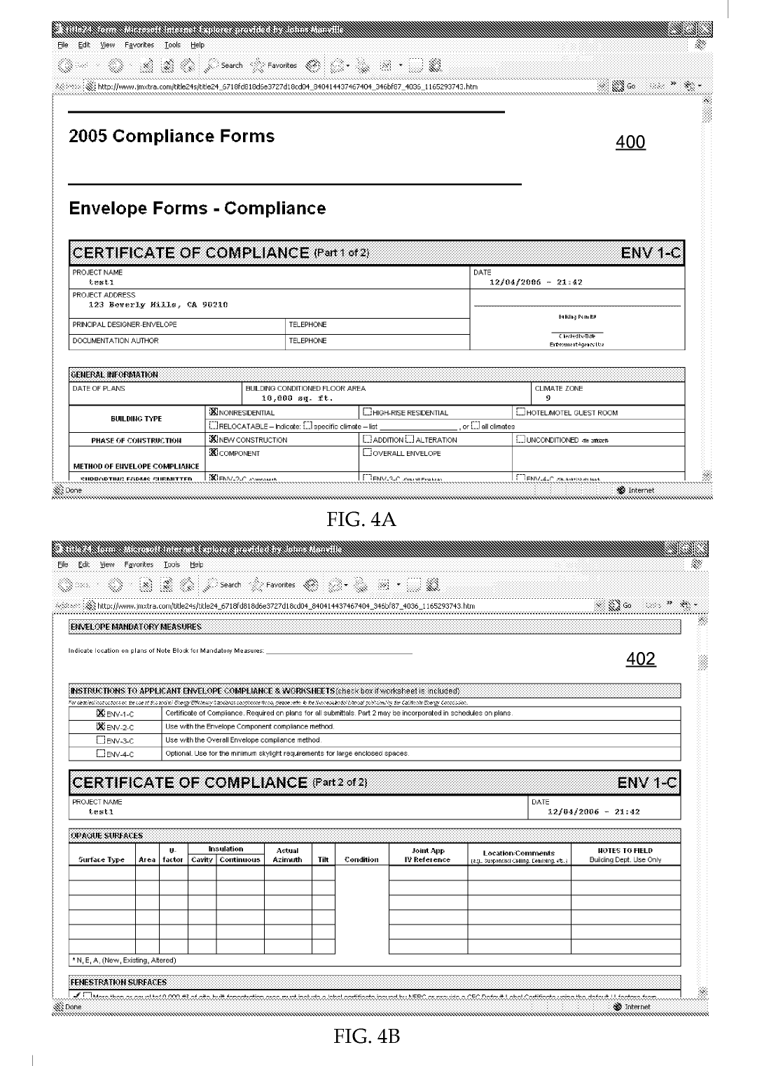

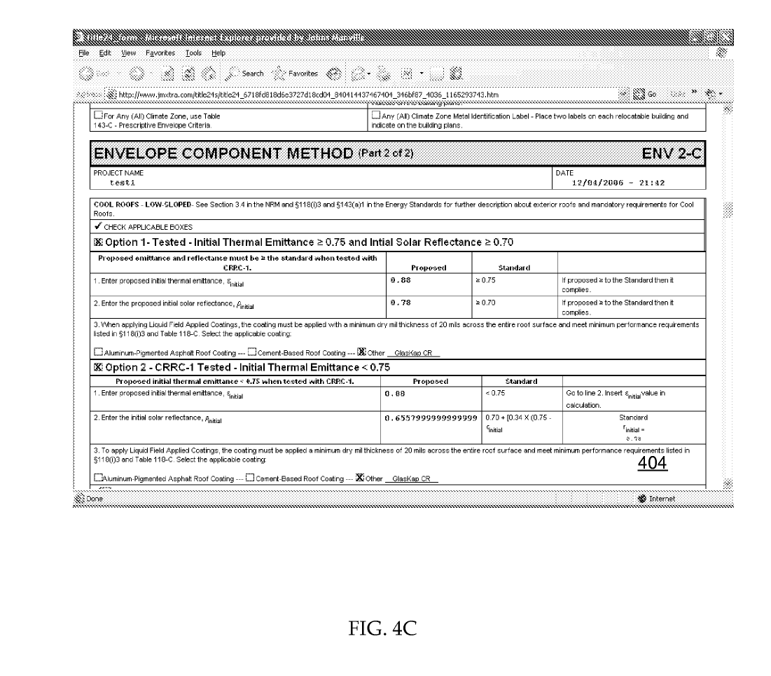

Another valuable benefit provided by embodiments of the present invention is compliance forms generation. Depicted as block 212 of FIG. 2, the tool may generate forms, suitable for submission to the appropriate regulatory agency, that document that the chosen system complies with the requirements. FIGS. 4A to 4C depict exemplary forms to demonstrate compliance with California Code of Regulations Title 24, Part 6. The form includes information necessary for the agency to evaluate compliance. Those skilled in the art will appreciate that the tool may be used to generate compliance forms relating to other jurisdictions.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Moreover, those skilled in the art will appreciate that the concepts discussed herein may be directed toward other types of compliance systems and methods. Accordingly, the above description should not be taken as limiting the scope of the invention, which is defined in the following claims.

What is claimed is:

1. A compliance system configured to assist a user with the selection of building materials that comply with a regulatory requirement, the compliance system comprising:
a processor;
a forms generator; and
a user interface;
wherein the processor is programmed to:
receive a first user input via the user interface, which first user input identifies a geographic area within a larger compliance region to which the regulatory requirement relates, wherein the geographic area has particular compliance parameters associated therewith;
receive a second user input via the user interface, which second user input identifies a first building material;
based on the first and second user inputs, identify a second building material usable in combination with the first building material to comply with the regulatory requirement;
via the forms generator, generate one or more forms that document compliance with the regulatory requirement.

2. The compliance system of claim 1, wherein the regulatory requirement relates to energy efficiency requirements for a building.

3. The compliance system of claim 1, wherein the regulatory requirement relates to a roofing requirement.

4. The compliance system of claim 1, wherein the regulatory requirement relates to California Code of Regulations Title 24, Part 6.

5. The compliance system of claim 1, wherein the first user input comprises a zip code.

6. The compliance system of claim 5, wherein the zip code is usable by the processor to identify a climate zone within which the building materials are to be used.

7. The compliance system of claim 1, wherein the first and second building materials comprises different components of a roofing system.

8. The compliance system of claim 1, further comprising:
a material list generator, wherein the processor is further configured to, via the material list generator, generate a list of materials.

9. The compliance system of claim 1, further comprising:
a jurisdictional table identifying regulatory requirements for one or more jurisdictions within which the building materials are usable;
a climate zone table identifying climate data for a plurality of climate zones within which the building materials are usable; and
a material properties table identifying material properties for a plurality of building materials.

10. A method of complying with a regulatory requirement relating to energy efficiency, comprising:
providing a computer-implemented compliance tool;
providing data to the tool that defines a first building material and a compliance location;
receiving from the tool information defining a second building material usable in combination with the first building material to comply with the regulation at the compliance location.

11. The method of claim 10, wherein the regulatory requirement relates to a roofing requirement.

12. The method of claim 10, wherein the regulatory requirement relates to California Code of Regulations Title 24, Part 6.

13. The method of claim 10, wherein the first and second building materials comprises different components of a roofing system.

14. The method of claim 10, further comprising generating a project-specific materials list.

15. The method of claim 10, further comprising generating one or more project-specific compliance forms.

16. A method of complying with an energy efficiency standard relating to roofing systems, comprising:
providing a compliance tool that is configured to receive information from a user defining at least a first component in a multi-component roofing system and to identify at least a second component in the multi-component roofing system, wherein the first and second components are usable in combination to comply with the energy efficiency standard, and wherein the compliance tool is further configured to generate one or more forms acceptable to a regulatory agency as documentation of compliance with the energy efficiency standard;
inputting into the tool data defining the first component; and
outputting from the tool data defining the second component.

17. The method of claim 16, wherein the energy efficiency standard relates to California Code of Regulations Title 24, Part 6.

18. The method of claim 16, further comprising generating a project-specific materials list.

19. The method of claim 16, further comprising generating one or more project-specific compliance forms.
